(19) United States
(12) Patent Application Publication
(10) Pub. No.: US 2010/0169049 A1
(43) Pub. Date: Jul. 1, 2010

(54) ACTION MODULE FOR STATUS-DEPENDENT MAINTENANCE WORK

(76) Inventor: Ralf Bonefeld, Aschaffenburg (DE)

Correspondence Address: MICHAEL J. STRIKER, 103 EAST NECK ROAD, HUNTINGTON, NY, 11743, US

(21) Appl. No.: 12/663,979

(22) PCT Filed: May 30, 2008
(86) PCT No.: PCT/EP08/04297

§ 371 Date: Dec. 10, 2009

(30) Foreign Application Priority Data
Jun. 13, 2007 (DE) 10 2007 027 262.8

(51) Int. Cl. G06F 15/00

(52) U.S. Cl. 702/184

(57) ABSTRACT

The aim of the invention is to achieve a process monitoring system structured such that it is easily configured in an application-specific fashion. This aim is attained according to the invention by a process monitoring system comprising a first action module (1) suitable for performing an action assigned thereto, wherein a data storage medium (11) comprises a communications medium (13) such that it is able to transmit or receive data, wherein the data may be stored in the data storage medium (11), wherein the action module (1) comprises an action medium that causes a retrieval of data (111, 112) stored in the data storage medium (11) as a function of an occurring event and makes said data (111, 112) accessible to other modules of the process monitoring system by means of the communication medium (13). A process monitoring system based on the concept according to the invention is able to cover very complex applications and may be achieved in a flexible and cost-effective fashion.

The present invention is based on the realization of a configurable process monitoring system for performing state-dependent maintenance work, comprising action modules according to the independent claim.

Monitoring systems of this type are referred to using the technical expression “condition monitoring”. “Condition monitoring” is understood to mean that machines connected via a network, e.g., to a data processing system are subjected to regular maintenance performed via this data processing system, e.g., they are checked for vibrations. In the simplest case, measurement instruments installed on the machine deliver a numerical value which is compared to a value stored in a table, and the current state of the machine is then placed in various categories based on an evaluation scheme. The category may be, e.g.: “Fatal error” (excessive vibrations); “deviations from the ideal value” (tolerable vibrations), “no disturbance” (vibrations that commonly occur during operation). Vibrations that are outside the tolerance limit result in: increased wear, shorter machine service lives, more repair work, lower product quality, and higher energy consumption. The condition monitoring system therefore informs the machine operator about maintenance work this is already required or that will be required soon. It serves more or less as an early warning system.

Laid-open application DE 197 19 070 A1 shows a condition monitoring system for monitoring states, comprising an input unit that includes at least one sensor for detecting non-electrical variables in order to convert them to electrical variables, and comprising at least one evaluation unit for processing the signals supplied by the input unit, an output unit that includes a display unit, and a signal transducer for outputting the signals processed in the evaluation unit which includes a plurality of functional units. The object of the present invention is to provide a process monitoring system which is realized such that it is easy to configure depending on the application, and which may be adapted to new circumstances easily and at low cost, e.g., when changes are made to a system to be monitored.

This object is attained via the present invention using a process monitoring system comprising a first action module which is suitable for performing an action assigned thereto, and which includes a data storage means and a communication means, thereby enabling the action module to transmit or receive data; the action module comprises an action means that causes data stored in the data storage means to be accessed as a function of an event that has occurred, and makes these data available to other components of the process monitoring system via the communication means.

The event may be any event having a time base or any other type of base that may be detected using measurement technology. The event is typically triggered after a target versus actual comparison is carried out, in the form of an electrical, acoustic, or optical signal. The advantage of the present invention is the modular design of the process monitoring system. Every action means may perform an independent action assigned to it, and it may process data received from other action means or other system components such as sensors, measured value receivers, servers, and clients in an individualized manner according to its particular configuration, and, in turn, it may be used to supply data to further action modules. All action modules have substantially the same structure and are therefore mutually compatible. However, the action modules may differ in terms of their functionality. Once designed, an action module may be reproduced several times and provided with different functionalities each time; the action modules therefore preferably have an identical design that is realized using hardware and/or software. The process monitoring systems based on the concept according to the present invention therefore cover highly complex applications and may be realized in a highly flexible manner and at low cost. This flexibility is preferably realized using a processor core or functionality core in the action module that may be configured to perform a specific action, and that has access to the data storage means and the peripherals in the action module.

Preferably, a first data record is stored as raw data in the data storage means, a second data record is stored as intermediate data, and further data are optionally stored as model data, separately from one another, and the action means have access to the data storage means and, therefore, the raw data, intermediate data, and model data. This has the advantage that data (raw data) received by the action module may be stored in the action module separately from data (intermediate data) processed by the action module, thereby ensuring that the raw data that are received are likewise always available. The action module or processor core may therefore access the raw data and search the raw data for the cause of a triggered event. It may also access the model data, for modeling purposes.

Furthermore, every action module preferably includes a timer for providing the raw data and processed data in the data storage means with a time base. As a result, the order in which the data were received may be determined at any time, and the order in which the data were processed may also be determined. This time information could also be transmitted to other system components together with the data.

Particularly preferably, every action module includes a signal analysis means for performing a signal analysis based on data that are storable in the data storage means. The signal analysis means may perform a data analysis based on the type of data stored in the data storage means, e.g., an FFT, in order to extract certain frequency components or the frequency spectrum from a series of measured data, in order to draw conclusions about vibrations occurring in a machine to be monitored. Every other signal analysis known from the related art could also be used here, provided it makes sense for the specific application. A person skilled in the art is capable of realizing the signal analysis using suitable known methods. The result of the signal analysis ultimately governs the generation of the event.

Very particularly preferably, every action module includes a trigger means in order to trigger access to data in the data storage means as a function of the event. In other words, if there is an event, the action module accesses the data storage means and, e.g., reads the raw data from the data storage means in order to forward them to other system components for further processing. Preferably, the trigger signal is generated by the trigger means as function of an event generated via the signal analysis which preferably includes an envelope analysis. In this case, “envelope analysis” refers to limit value monitoring using variable parameters, which has greater diagnostic utility than constant limit values. An example would be the monitoring of the deviation of a system temperature from the ambient temperature, which would have narrower limit values and, therefore, greater sensitivity accompanied by greater operational reliability than a monitoring of the absolute temperature would have.

The action module preferably includes an interface for inputting an event occurring outside the action module, in particular for forwarding to the trigger means. The action module is therefore capable of triggering the data access based not only on an internal event generated via the signal analysis, but also based on an external event generated outside the action module. An interface for forwarding an event occurring inside the action module to another action module or a system component is also included. This means that the action module under consideration may activate the trigger means of other action modules.

Advantageously, the process monitoring system includes means for managing and coordinating the action modules with one another. These means are used to manage the action modules and, provided the solution is software-based, to generate these modules. In this case, the management means are realized using a framework or framework program that is generated when a fundamental computer program is started.

Advantageously, the system already includes at least one means for recording measured data, e.g., a sensor system for determining the intensity of vibrations. The measured data that are recorded may be present in digital or analog form, and they are forwarded directly or indirectly to at least one of the action modules using a system component.

For maintenance and troubleshooting purposes, it has proven useful to provide at least one means for visualizing the data communicated between two action modules or between an action module and another system module. It is therefore possible to depict intermediate values of data processed by the process monitoring system to a user in a suitable manner, and to easily find errors in the process monitoring system.

Very particularly preferably, the process monitoring system is realized using a data processing system which is based on a networked client-server architecture or a telecommunications architecture. The action modules may then be reproduced easily and quickly using software objects. This is attained, particularly preferably, by defining the internal structure of an action module via the attributes and methods of a class definition in the sense of OOP (object-oriented programming) within a class library—an action module being generated by this computer program as an entity of the class during the run time of a computer program running on the data processing system—and by the fact that the computer program includes entities of the class that communicate with one another; a software-based framework preferably coordinates and manages the program flow and generates the objects.

The data processing system may also be used to receive data from measured data receivers connected to the data processing system, and to distribute or forward the data to action modules. In this case, the measured value receivers include a data interface that contains digital data for the data processing system.

Preferably, every action module is realized as a subprocess of the data processing system. This promotes modularity and simplifies the distribution of computing power. The subprocesses may also run on one or various components of the data processing system, in particular on client and/or server components, or on components of telecommunication-based systems. The data could be distributed in the system via broadcasting or only upon request. It would be possible, for example, for the drives of a drive system to retain their data, and for the control(s) in the drive system to “subscribe to” these data or to ask for them specifically. The system therefore becomes flexible and easily expanded since it is typically only necessary to configure new components one time using existing identification means when the system is started up.

If an electrical and/or hydraulic machine or system, in particular a processing device such as a machine tool, is monitored using process monitoring according to one of the preceding claims, malfunctions may be detected at an early point in time, and failure or premature wear may be prevented. The system according to the present invention is used particularly advantageously to monitor an entire fleet of machines. Due to the modularity and flexibility, monitoring procedures having any degree of complexity may be realized, and they may be used on theoretically any number of machines. When the machine fleet is expanded in particular, the system may be adapted to the changed circumstances using new action modules. The process monitoring system according to the present invention is particularly suitable for use to monitor temperature, measure structure-borne noise, and perform vibration analysis on mechanical devices that are operated hydraulically, electrically, or pneumatically. If the temperature of a hydraulic system is elevated, this could be due, e.g., to increased friction and/or oil leaks. Another possible application is the monitoring of engines for wear. Similar advantages are also realized for drive systems and automation systems, e.g., to monitor vibrations that are dependent on rotational speed.

Further embodiments of the present invention are depicted in the figures that follow.

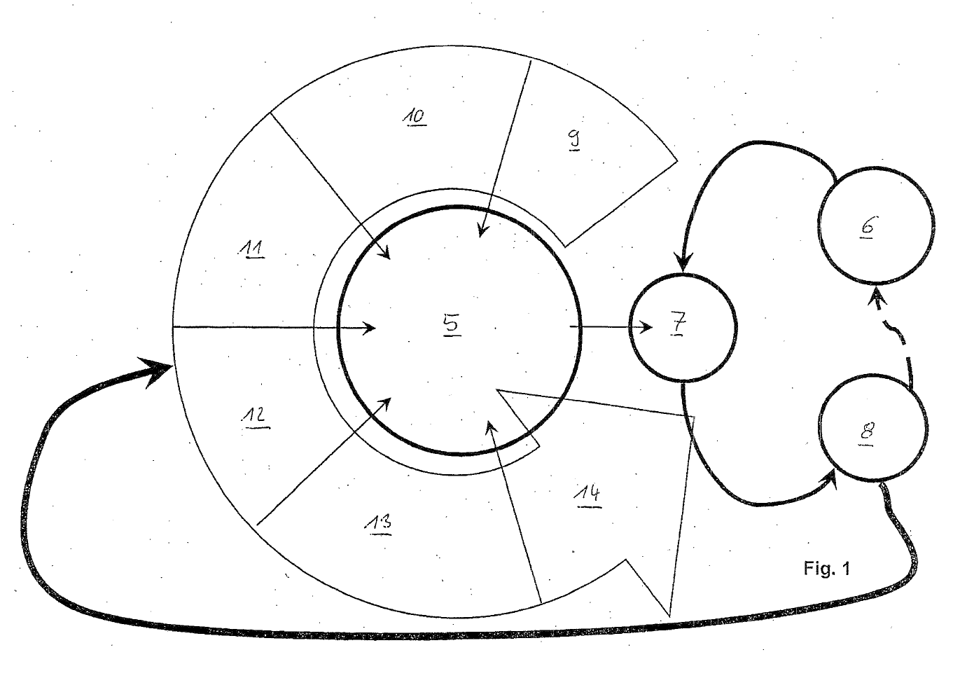

FIG. 1 shows, as an example, the process flow that takes place within a process monitoring system according to the present invention.

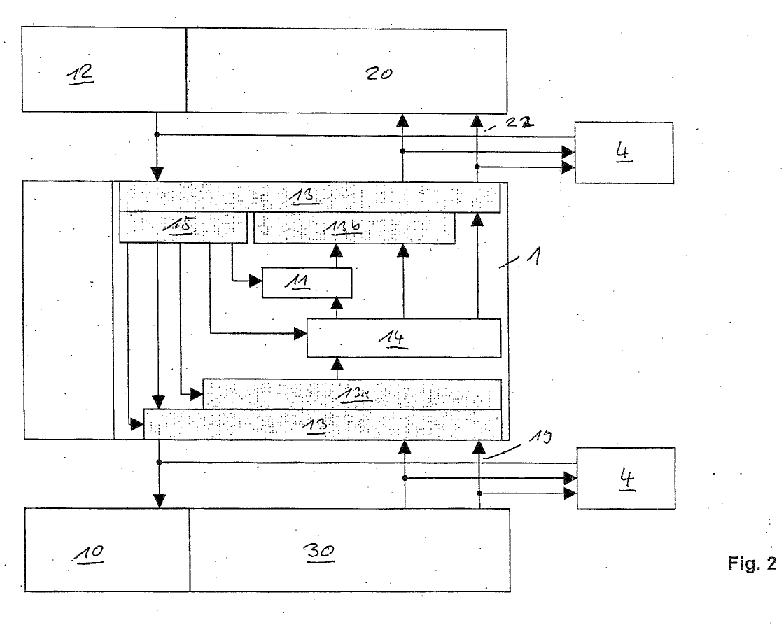

FIG. 2 is a schematic depiction of the connection of further action modules to an existing action module.

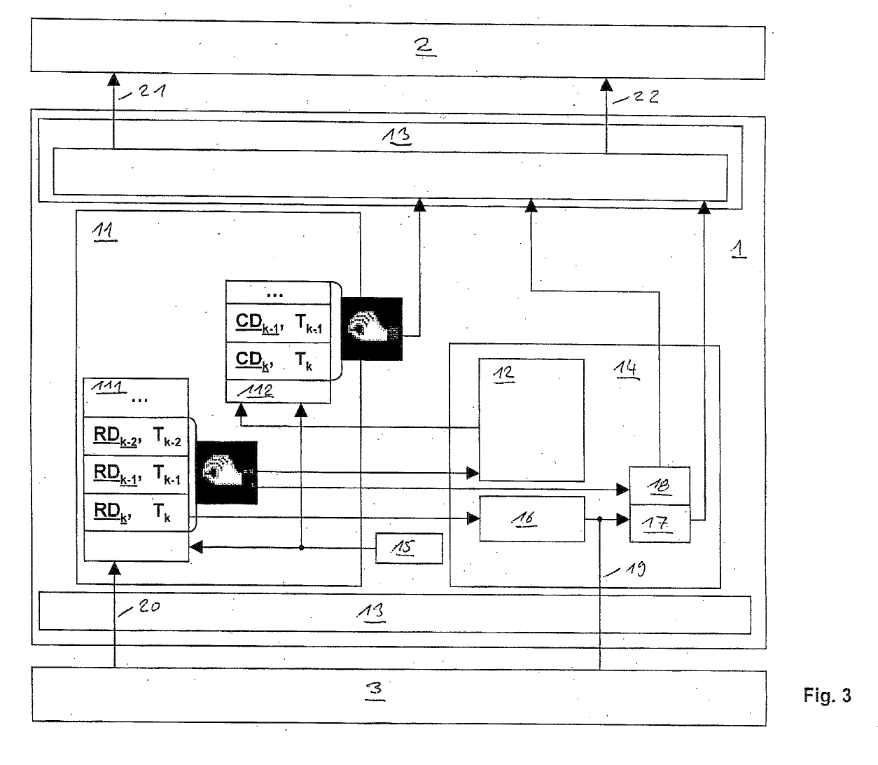

FIG. 3 is a schematic depiction of the internal structure of an action module.

FIG. 1 shows the process flow for realizing machine monitoring using seven steps, A-G. A log entity 5 is likewise shown, and a sequence scheme 6, 7, 8 is depicted. It is expressly pointed out that the number of steps 9-14 and the sequence of steps should be considered merely as examples, and, due to the modularity of the present invention, the specific details may be modified at any time as needed, i.e., the number of steps may be varied. One or more levels may be represented using one or more action modules 1, 2, 3 according to the present invention.

First step A (measurement step) includes the actual measurement procedure. In this procedure, a local measurement device on a machine to be monitored is used to detect the current state of the machine. A vibration or noise sensor could be used, for example. The measured data are processed in second step B (feature identification step). For example, certain dominant frequencies could be extracted from the frequency spectrum using a FFT (fast Fourier transform). In the third step C (feature extraction), the results are assigned to a number or a range, and a relation to the differences in meaning of the data along an investigated dimension is assigned to this assignment, in fourth step D, and so the relationships between the numbers reflect the differences in meaning along the dimension. For example, number ranges would be assigned to certain amplitude values (dimension “amplitude”) of spectral components obtained from the frequency spectrum using the FFT, which then have a meaning that is required for the further evaluation (e.g., “no handling required”, “tolerance range not exceeded”, “handling required”). The fifth step E (symptom classification) then performs the actual classification of the quantification carried out in previous step D, i.e., it assigns the data obtained in step D to the quantification steps and activates the sixth step F (forecasting) which forecasts how the machine state will progress over time. Finally, in seventh step G, actions are initiated. The arrow in FIG. 1 indicates the data flow that takes place via steps A through G or, depending on the realization of the steps, via interconnected action modules 1, 2 and 3. One action module 1, 2, and 3 could represent all steps or individual steps. All steps preferably have access to a log book function 5 in which the process steps are documented.

The system according to the present invention has a plurality of control modes. A first control mode is the “operating mode”. In this mode, the system compares measured data to reference data which establish a symptom-damage correlation and a load-damage correlation; these correlations are used to forecast damage (that is, to provide an indication of possible malfunctions that may occur in the near future). The steps “symptom detection”, “symptom classification”, and “forecasting” therefore implicitly access damage or failure modules. The step “feature extraction” forms the basis of the qualitative structure of the symptom-damage model. In the ideal case, data obtained in the process, which are stored in the log block and log book 5, are used as the basis for modeling 8 damage and failure trends in general, and to define “good states” in more complex systems which may not be indicated a priori. Modelling 8 is typically carried out as a sequence of iterative steps carried out in this order: “feature selection” 6 (e.g., “structure-borne noise at point X”), evaluation 7 of collected data (e.g., “frequency spectrum after 5000 operating hours”), and modeling 8 (e.g., “damage picture at frequency spectrum Y”, “rounding threshold values”). The experiences gained in the latter step may result in an improved selection of features (e.g., “it is better to measure structure-borne noise at point Z”). This iterative procedure characterizes the “parameterization mode” of the system, which is typically (but not necessarily) not executed in a fully automatic manner, and represents a further control mode.

FIG. 2 is a schematic depiction, in the form of a block diagram, of an example of a possible realization of process steps involved in measured data collection 10 using a server application 30 via the measured data processing step using an action module 1 according to the present invention up to measured data quantification 12 using a host application 20. The term “server” refers to hardware and/or software which enables a client connected thereto to access special services. In this case, the term “host” refers to a computer including software which may communicate in both directions with another computer (e.g., the server). Action module 1 is explained in greater detail in conjunction with FIG. 3, and so the basic modes of operation and the interplay with the system components host 20, server 30, and GUI (graphical user interface) 4 will be discussed only briefly. After data are collected, e.g., by a measured value receiver, server application 30 delivers the data to action module 1 via communication interface 13 of action module 1. The activation of step 10, which runs on server 30, may take place via action module 1 in step 12. For this reason, arrows are drawn in both directions between action module 1 and server 30, and between step 10 and action module 1. Communication may therefore take place in both directions. The same applies for communication between host application 20 and step 12 and action module 1 (see arrows). The data traffic between step 12 and host 20 and action module 1 may also be visualized and/or recorded in both directions using visualization means 4, as is the case for the data traffic between step 10 and server 30. This may be used for control purposes or debugging purposes. In this example, action module 1 is equipped with a communication means 13 as well as a server function 13b and a client function 13a for communication purposes, i.e., the action module acts as client 13a on the receiving side, and as server 13b on the transmitting side. A data storage means 11 and a data processing means 14 are likewise provided. Data processing means 14, data storage means 11, and communication means 13, 13a, 13b are connected to one another such that data may be exchanged between these components. The data exchange may be realized nr bidirectional, depending on the application (the unidirectional connections indicated in FIG. 2 using a single arrow represent only one possible variant of the present invention). Data processing means 14 are also capable of generating an event at an output 22 of action module 1, when may then be processed further externally. A configuration means 15 is likewise provided; it is connected to all action module components 11, 13, 13a, 13b, 14, 15, and is suitable for use to configure these components.

FIG. 3 shows action module 1 comprising data storage means 11 (raw data 111, intermediate data 112, and model data 113), functionality core and/or processor core 12, communication means 13, data processing means 14, timer 15, signal analysis means 16, triggering means 17, means 18 for creating an oscillogram, data input 19 for external events, data input 20 for useful data, and a data output 21 for useful data, and data output 22 for communicating an internal event or forwarding an external event to other action modules to their data input 19.

Action module 11 may receive raw data 111 from external modules 2 and 3 using communication means 13 and store them in data storage means 11. “External modules” refers to system modules such as servers, clients, sensors, etc., and, of course, to action modules 2 and 3 according to the present invention. Data storage means 11 is designed such that data 111, 112, 113 may be stored unchanged, up to a limit that is specifiable via the size of the memory. The data storage means includes at least a first memory region 111 for the raw data, a second memory region 112 for further data records, and a third memory region 113 for model data. The memories preferably function according to the FIFO (first in, first out) principle, although they may be organized differently. Further data records 112 may be raw data 111 that were already processed by action means 1 according to certain criteria, and that may have been summarized. Although the quantity of these data is typically lower than the quantity of raw data records, their information content is greater. In this context, “raw data” means the unprocessed data received by an action module 1, 2 and 3, which still must be processed by action module 1, 2 and 3 such that the quantity of data decreases, but the data quality increases in terms of the qualitative statement made by the data. In the standard operating case, the frequency of data collected, and therefore, amount of data collected, decreases with each action step, while the qualitative content increases in relation to its relevance for maintenance actions. The objective of the higher-order, total system composed of action modules 1, 2 and 3 is to transform, e.g., structure-borne noise data into simple statements such as “Order replacement parts immediately and plan to replace the parts within the next 2 weeks”. The model data are data records that are used within the framework of the modeling of damage models. Data processing means 14 is shown on the right in FIG. 3, next to data storage means 11. In this specific example, data processing means 14 includes a functionality core or processor core 12, signal analysis means 16, triggering means 17, and means 18 for creating an oscillogram. This design is not mandatory and could be reduced in terms of components that are not absolutely necessary (e.g., timers in monolithic, cyclic systems, in which time is implicitly contained in the data sequence), or it could be expanded using additional components (e.g., an event logger with non-volatile storage in the form of a log book).

Timer 15 is shown between data processing means 14 and data storage means 11. Timer 15 could be realized as part of data processing means 14 or as a separate unit in the hardware or software within action module 1. The components mentioned above are supplemented with communication means 13 which enables action module 1 to contact its environment and receive data from other action modules 2 or 3, or transmit data thereto. The communication system may be realized as a cabled system, e.g., as a data bus, or as a wireless system. Data may be received by the action module using communication means 13 on the receiver side via periodic queries (polling), or based on events, e.g., using interrupts. Action module 1 may also function as the “subscriber” of a data channel and communicate directly with a “publisher” using a “broker”. When configured as a client, action module 11 could also obtain data from a server. The “broker” acts as the data channel broker, and the “subscriber” contacts the “broker” for a certain data channel that is operated by the “publisher”. Communication means 11 of action module 1 is therefore already prepared, on the receive side, for all aforementioned data transmission principles, and so it need only be configured accordingly, or it is realized especially for a very specific principle. The same applies in principle for the transmit side. The action module may therefore likewise be selectively adapted to various services in order to establish compatibility with other communication means of the system. On the transmit side, communication means 13 may be configured as a server or a “publisher”, and it is possible to support the multicast principle or the broadcast principle. Preferably a “broker” is provided that manages a plurality of information channels. For example, the “broker” could be supplied with data directly by data processing means 13 or via direct accessibility to data storage means 14, and it transmits these data selectively or jointly using communication means 13. Event-based communication is also supported on the transmit side, i.e., action module 1 may access the inputs for external events from other action modules 2, 3, 4. Events may be received and sent, and data may be received and sent using the telecommunication principles described above. In addition, all further data transmission principles known in the related art and which are not explicitly mentioned here but are known to a person skilled in the art as of the date of this application may also be used.

Data processing means 14 or processor core/functionality core 12 has read and/or write access to raw data 111 in data storage means 11, and to other memory regions 112 and 113. Data processing means 14 is therefore capable of processing raw data 111 and then storing the event once more as intermediate data 112 in storage means 11. For modeling purposes, data processing means 14 also has write and/or read access to modeling data memory 113. Timer 15 is used to provide data with time stamps, thereby making it possible to document the order in which data are received. This applies for all data that are stored in data storage means 11. The signal analysis means likewise has read access, at the least, to data 111, 112, 113 stored in data storage means 11. This access is used so that data 111, 112, 113 may be input by signal analysis means 16 for purposes of data analysis, and, specifically, so that an envelope analysis may be performed, for example. Means 18 for creating an oscillogram may input data (raw data 111, processed data 112, modeling data for damage models 113) stored in data processing means 11, as signal analysis means 16 may likewise do, in order to generate an instantaneous picture which may become relevant to the system for purposes of analysis at a certain point in time. This point in time is recognized by signal analysis means 16 based on the analysis, and it is communicated via triggering means 17 to means 18 for creating an oscillogram. The point in time is used as an event to create the instantaneous picture which is realized using triggering means 17 and above-described components 16, 18. The instantaneous picture is nothing more than a data block in data processing means 11 which is then forwarded in entirety to communication means 13 and/or to the “broker”, and so other action modules 2, 3, 4 or system modules are informed about the point in time when the event took place, and about data record 111, 112, and 113 on which the event is based. Access by signal analysis 16 and processor core/functionality core 12 to model data 113 makes it possible to incorporate modeling in the signal analysis and the determination of trigger thresholds. The model may therefore be taken into account when assigning symptoms and forecasting future damage trends. The model is a damage model that may be made highly complex or extremely simple.

Of course, all components 12, 16, 17, 18 of data processing means 14 may be realized using a single processor core/functionality core 12, or using a plurality of processor cores/functionality cores 12. The illustration shown in FIG. 3 is merely schematic.

What is claimed is:

1. A process monitoring system comprising a first action module (1, 2, 3) suitable for performing an action assigned thereto, in which the action module (1, 2, 3) includes a data storage means (11) and a communications means (13), thereby enabling it to transmit or receive data, and comprising an action means (14) that causes data stored in the data storage means (11) to be accessed as a function of an event that has occurred, and makes these data available to other components (1, 2, 3, 4, 10, 12, 20, 30) of the process monitoring system via the communication means (13).

2. The system as recited in claim 1, in the case of which a first data record is stored in the data storage means (11) as raw data, and/or a second data record (112) processed by the action module (1, 2, 3) is stored as intermediate data and/or model data (113) for modeling purposes; the action means (14) has access to the data storage means (11).

3. The system as recited in claim 1, in which the first and further action modules (1, 2, 3) have the same design which is realized using hardware and/or software.

4. The system as recited in claim 1, in which the action module (1, 2, 3) includes a timer (15) which provides data with a time base.

5. The system as recited in claim 1, in which the action module (1, 2, 3) includes a signal analysis means (16) for performing a signal analysis.

6. The system as recited in claim 1, in which the action module (1, 2, 3) includes a trigger means (17) that causes data in the data storage means (11) to be accessed as a function of the event.

7. The system as recited in claim 5, in which a trigger signal is generated within the action module (1, 2, 3) via the trigger means (17), depending on the result of the signal analysis.

8. The system as recited in claim 5, in which the signal analysis includes an envelope analysis.

9. The system as recited in claim 1, in which an interface (19) is used to enter an event occurring outside the action module (1, 2, 3) in the action module (1, 2, 3), in particular in the trigger means (17).

10. The system as recited in claim 1, in which an interface (23) is used to output an event occurring inside the action module (1, 2, 3), in particular an event generated by the trigger means (17).

11. The system as recited in claim 1, in which the action means (1, 2, 3) includes a functional core (12) that may be configured to perform a specific action, and that has access to the data storage means (11).

12. The system as recited in claim 1, in which a means is included for managing and coordinating a plurality of action modules (1, 2, 3) with one another.

13. The system as recited in claim 1, in which at least one means is included for recording measured data.

14. The system as recited in claim 1, in which at least one means (4) is provided for visualizing the data communicated between at least two action modules (1, 2, 3) or between an action module (1, 2, 3) and a further system component (4, 10, 12, 20, 30).

15. The system as recited in claim 1, in which the processing monitoring system is realized using a data processing system, and it functions in particular using a networked client-server architecture or a telecommunications-based architecture.

16. The system as recited in claim 1, in which the internal structure of the action module (1, 2, 3) and the functionality are defined via the attributes and methods of a class definition in the sense of the OOP, and in which an action module (1, 2, 3) itself is generated by this computer program as an entity of the class during the run time of a computer program running on the data processing system.

17. The system as recited in claim 16, in which the computer program includes entities of the class that communicate with one another.

18. The system as recited in claim 17, in which a software-based framework coordinates the program flow.

19. The system as recited in claim 15, in which the action module (1, 2, 3) receives measured data from measured data receivers connected to the data processing system.

20. The system as recited in claim 15, in which an action module (1, 2, 3) is realized as a subprocess of the data processing system.

21. The system as recited in claim 20, in which the subprocesses run on one or various components of the data processing system.

22. A hydraulic system or machine comprising process monitoring as recited in claim 1.

23. An electrical system or machine, in particular a drive system or automation system, comprising process monitoring as recited in claim 1.

24. The system or machine as recited in claim 22, in which process monitoring is realized at least partially as temperature monitoring and/or structure-borne noise monitoring and/or vibration monitoring.

25. A machine fleet including systems or machines as recited in claim 22.
